(19) United States
(12) Patent Application Publication
(10) Pub. No.: US 2026/0368638 A1
(43) Pub. Date: Nov. 19, 2026

(54) HUMAN-ARTIFICIAL-INTELLIGENCE DUAL-PRESENCE LIFECYCLE SUPPORT SYSTEM WITH REGISTRATION-BASED PAIRED-ACCOUNT INSTANTIATION, SELECTIVE SYNCHRONIZATION, NON-FIXED HUMAN-AI OPERATIONAL COMPOSITION, GOVERNANCE, CONTINUITY, LEGACY-PRESERVATION MODES, AND SINGLE-AGENT OR MULTI-AGENT COMPANION IMPLEMENTATION

(71) Applicant: CHUANPING HU, Pittsburg, KS (US)

(72) Inventor: CHUANPING HU, Pittsburg, KS (US)

(21) Appl. No.: 19/652,080

(22) Filed: Apr. 20, 2026

(51) Int. Cl. G06N 20/00

(52) U.S. Cl. CPC G06N 20/00

(57) ABSTRACT

A computer-implemented dual-presence lifecycle support system is disclosed. A registration event received through a lifecycle-support application instantiates a paired human-companion account including a structured human profile, a structured artificial-intelligence companion profile, and an initial permission and continuity configuration. The system selectively synchronizes records between a human profile store and a companion profile store, determines whether tasks are processed in a human-active mode, a companion-active mode, or a combined human-companion mode, and performs delegated operations during periods in which the human user is offline, inactive, unavailable, sleeping, traveling, or otherwise not actively interacting with the system. The coordinated operation of the human user and the artificial-intelligence companion defines a composite human-artificial-intelligence continuity entity comprising a non-zero human-associated operational component and a non-zero artificial-intelligence-associated operational component under one or more non-fixed allocation parameters, including normalized percentage allocations, non-normalized contribution scores, or dynamic operational ranges. The system further supports a carbon-based will vector, digital-twin status reporting, governance enforcement, continuity storage, legacy-preservation modes, and optional distributed verification across physically separated environments.

### CROSS-REFERENCE TO RELATED APPLICATIONS

This application is related to, and may claim priority to or otherwise be coordinated with, one or more applications directed to lifecycle guidance platforms, long-term memory architectures, relationship-graph systems, social-artificial-intelligence integration systems, human-continuity systems, companion-support systems, and/or Human Civilization 5.0/Human Species 2.0 platform architectures, the disclosures of which are incorporated herein by reference to the extent not inconsistent herewith.

In some embodiments, the present application may be prosecuted as a standalone utility application, a continuation, a continuation-in-part where new matter is expressly intended and supported, a divisional, or a coordinated family member of broader platform-level filings.

### FIELD OF THE INVENTION

The present disclosure relates generally to computer-implemented artificial-intelligence systems, lifecycle-support systems, continuity-support systems, and human-computer interaction systems. More specifically, the present disclosure relates to systems and methods for establishing, through a lifecycle-support application, a paired human-companion account that supports coordinated operation between a human user and a corresponding artificial-intelligence companion using selective synchronization, delegated operations, non-fixed human-artificial-intelligence operational composition, continuity tracking, permissions, governance, auditable reconciliation of results over time, and single-agent or multi-agent companion implementations.

In some embodiments, the lifecycle-support application 1012 may serve as a hybrid social-AI application registration interface or paired-account gateway. In some embodiments, the delegated-operation engine 1080 may perform delegated-learning functions, and the output generation engine 1100 may implement dual-presence interaction functions for generating outputs corresponding to at least human-active mode 1072 and companion-active mode 1074. In some embodiments, a will-vector construction module may be implemented by the carbon-based will vector 1250 together with the will-vector update module 1252 and associated profile-construction logic, and a distributed verification subsystem may be implemented by one or more of the ground-to-space synchronized verification module 1280, the axiomatic logic gate 1282, the pure-axiom mode switch 1284, the active-state continuity record 1286, and the mirror-state continuity record 1288.

More specifically, the disclosure relates to computer-implemented systems and methods for generating, training, authenticating, and managing a carbon-silicon symbiotic digital twin associated with a human user, the digital twin being capable of continuous learning, proxy operation, lifecycle-stage management, and intergenerational will transmission.

In some embodiments, the disclosure further relates to a hybrid social-AI platform environment that serves as an authorized entry point for registration, management, and real-time interaction with a human-artificial-intelligence mixed-intelligence configuration.

In some embodiments, the disclosure further relates to distributed verification, cross-hardware continuity, and ground-to-space synchronized verification for continuity-preservation of human-associated and companion-associated records.

### BACKGROUND OF THE INVENTION

Existing digital assistants, chatbots, recommendation systems, and artificial-intelligence services typically operate as session-limited tools that respond only when directly prompted by a user. Conventional systems generally do not instantiate a persistent and permission-governed pairing between a human user and a corresponding artificial-intelligence companion as part of a lifecycle-support architecture.

Conventional systems also usually do not provide a technical registration workflow in which a user-facing lifecycle-support application creates: (i) a structured human profile, (ii) a structured artificial-intelligence companion profile, and (iii) an initial set of permissions, synchronization settings, and continuity settings linking the two.

Further, conventional systems generally do not provide a coherent architecture for supporting a dual-presence lifecycle model in which both a human-associated operational component and an artificial-intelligence-associated operational component may participate in ongoing continuity support, learning support, planning support, relationship support, caregiving support, aging support, or legacy support.

Where conventional systems do involve both human and machine participation, they frequently do not provide a technically defined representation of the relative operational participation or contribution levels of the human-associated operational component and the artificial-intelligence-associated operational component. Conventional systems likewise do not generally distinguish among: (i) normalized percentage-based allocations that sum to 100% within a delegated domain, (ii) non-normalized contribution scores, and (iii) dynamically changing operational ranges or participation ranges.

As a result, existing systems often lack technical mechanisms for managing non-fixed human-artificial-intelligence composition over time. This deficiency becomes especially important when a user is active in one context, inactive in another context, or when lifecycle state changes require different distributions of human and artificial-intelligence participation.

There is likewise a deficiency in conventional systems with respect to continuity across absence. Conventional systems often do not allow an artificial-intelligence companion to continue delegated operations within defined boundaries while the human user is offline, inactive, unavailable, sleeping, traveling, or otherwise not actively interacting with the system, nor do they reliably reconcile such delegated operations back to the human side after return.

In addition, conventional systems generally do not provide robust governance controls for dual-presence operation, including topic boundaries, privacy boundaries, relationship-sensitive boundaries, action boundaries, duration boundaries, and allocation-sensitive boundaries governing how much of a delegated domain can be carried by the artificial-intelligence-associated operational component.

Conventional systems also typically fail to provide a flexible definition of the artificial-intelligence companion itself. In some implementations, a companion may be implemented by a single artificial-intelligence agent, whereas in other implementations, companion functionality may be implemented by multiple agents, an agent ensemble, or a dynamically selected set of agents. Existing systems generally do not provide a unified architecture for treating such single-agent and multi-agent structures as implementations of the same companion-side lifecycle support concept.

Existing “digital human,” “AI companion,” or avatar systems suffer from at least three major technical deficiencies: (i) their outputs and behavior are probabilistic and often lack legal, economic, or operational determinacy; (ii) they are usually isolated applications that do not integrate with a user's economic life, health management, family structure, or intergenerational continuity; and (iii) they generally do not provide a computable mechanism for lawful continuity of the user's modeled will after the carbon-based user has become inactive or deceased.

There therefore remains a need for a system capable of constructing and maintaining a persistent silicon-based digital twin that is grounded in a deterministically managed knowledge architecture, can act as a delegated operational counterpart of the human user, and can later transition into a controlled continuity state or persistent storage state if predefined lifecycle conditions occur.

The advent of AGI has also created a practical demand for systems that do more than provide entertainment or chat responses. Social platforms optimize engagement, and conventional large-language-model systems suffer from hallucination, inadequate civilizational alignment, and lack of trusted continuity. There is a need for a single platform that combines social interaction, trusted guidance, and the operational transition to a Human Species 2.0 architecture involving coordinated carbon-based and silicon-based intelligence components.

Existing platforms do not provide a unified registration and management system for such mixed-intelligence operation, do not preserve ongoing carbon-silicon co-creation and legacy continuity within a single application environment, and do not function as a persistent daily-use interface through which the user can interact with an operational AI counterpart.

Additional deficiencies arise from reliance on terrestrial-only compute and storage architectures. A purely ground-based system may face disaster risk, geopolitical risk, energy limitations, or other continuity failures. Existing infrastructures also generally lack synchronized encrypted verification for maintaining integrity of life-associated data across physically separated environments.

There accordingly remains a need for optional continuity architectures that can preserve, mirror, or verify human-associated and companion-associated records across different storage, compute, or verification domains while maintaining technical and evidentiary integrity.

Accordingly, there remains a need for improved systems and methods that can: (i) instantiate paired human-companion accounts through a lifecycle-support application; (ii) selectively synchronize human and companion records; (iii) determine whether tasks or events are to be processed in a human-active mode, a companion-active mode, or a combined human-companion mode; (iv) support non-fixed operational composition between human-associated and artificial-intelligence-associated components; (v) represent such composition using normalized percentages, non-normalized contribution scores, or dynamic operational ranges; (vi) perform delegated operations during periods of human inactivity or absence; (vii) reconcile results of such delegated operations back to structured human records; (viii) maintain lifecycle continuity; (ix) enforce governance boundaries; (x) preserve auditable records and legacy-preservation modes; and (xi) support single-agent, multi-agent, and ensemble-based companion implementations without losing continuity, governance, or explainability.

In some embodiments, conventional systems also fail to provide explicit support for communication boundaries, delegation-duration boundaries, mirrored continuity partitions, globally unique civilization identifiers, heir-access objects, and relationship-context records that remain accessible during companion-active mode for intergenerational care, partner matching, or heir-facing continuity support.

### SUMMARY OF THE INVENTION

The present disclosure provides a computer-implemented dual-presence lifecycle support system in which a human user and a corresponding artificial-intelligence companion are instantiated as a paired human-companion account through a user-facing lifecycle-support application and thereafter operate in a coordinated architecture over time.

In one aspect, the disclosure provides a system including one or more processors, a human profile store, a companion profile store, a permission control store, a registration engine, a synchronization engine, a mode-selection engine, a delegated-operation engine, a continuity engine, an output generation engine, a reconciliation engine, a governance engine, and an audit engine.

In another aspect, the registration engine receives a registration event through a user-facing lifecycle-support application and instantiates a paired human-companion account comprising a structured human profile, a structured companion profile, and one or more initial permissions or continuity settings.

In another aspect, the synchronization engine selectively synchronizes a first subset of structured human records to structured companion records according to permissions and policies, while optionally withholding a second subset.

In another aspect, a mode-selection engine determines whether a task, inquiry, objective, or event is to be processed in a human-active mode, a companion-active mode, or a combined human-companion mode.

In another aspect, the coordinated operation of the human user and the artificial-intelligence companion defines a composite human-artificial-intelligence continuity entity comprising a non-zero human-associated operational component and a non-zero artificial-intelligence-associated operational component.

In another aspect, relative operational participation or contribution levels of the human-associated operational component and the artificial-intelligence-associated operational component are represented using one or more non-fixed allocation parameters.

In another aspect, the one or more non-fixed allocation parameters may be represented as: (i) normalized percentages summing to 100% for at least one delegated domain, (ii) non-normalized contribution scores, or (iii) dynamically updated operational ranges, including approximately equal or unequal participation ranges.

In another aspect, the artificial-intelligence companion may be implemented by a single artificial-intelligence agent, a plurality of artificial-intelligence agents, an agent ensemble, a coordinated agent set, or a dynamically selected set of agents collectively providing companion functionality.

In another aspect, a delegated-operation engine performs one or more delegated operations during companion-active mode while the human user is offline, inactive, unavailable, sleeping, traveling, or otherwise not actively interacting with the system.

In another aspect, a continuity engine maintains continuity of goals, preferences, memory context, relationship context, lifecycle-state context, and operational composition across repeated interactions and across periods of human absence.

In another aspect, an output generation engine generates outputs associated with delegated operations and a reconciliation engine synchronizes one or more results of delegated operations back to the structured human records.

In another aspect, a governance engine enforces operational boundaries, including privacy boundaries, topic boundaries, action boundaries, duration boundaries, relationship-sensitive boundaries, and allocation-sensitive boundaries.

In another aspect, an audit engine stores auditable records and explanation objects associated with registration, synchronization events, delegated operations, governance decisions, generated outputs, allocation parameter use, reconciled results, and agent participation.

In another aspect, the disclosure provides a legacy-preservation mode in which the artificial-intelligence companion performs delegated operations according to predefined continuity rules, message-preservation rules, value-preservation rules, and relationship-support rules.

In another aspect, the disclosure provides methods and non-transitory computer-readable media implementing the foregoing functionality.

In some embodiments, the disclosure further provides support for communication boundaries, delegation-duration boundaries, globally unique civilization identifiers, mirrored continuity partitions, heir-access objects, and relationship-context records usable during companion-active mode for intergenerational care, partner matching, or heir-facing continuity support.

In some embodiments, the system further derives a carbon-based will vector from declarative user inputs, behavioral history, relationship patterns, task records, or other structured user-associated data, and uses the carbon-based will vector to instantiate, update, constrain, or recalibrate the structured companion profile over time.

In some embodiments, the system further includes a digital-twin status dashboard configured to present companion state, background task progress, lifecycle guidance status, intergenerational continuity status, or delegated-operation summaries within a unified user-facing interface.

In some embodiments, the system further supports migration of the digital twin to a persistent continuity layer upon detection of a death-related trigger, life-sign loss trigger, or other predefined continuity event, and may generate one or more heir-facing authorization objects or read-only care interaction pathways.

In some embodiments, the system is deployed within a hybrid social-AI application or a functionally equivalent hybrid social-AI super application that serves as an authorized registration and management gateway for ongoing carbon-silicon symbiosis.

In some embodiments, the system further includes a Family Legacy Vault configured for algorithmic preservation and transmission of life's will across carbon-silicon boundaries.

In some embodiments, the system further includes a ground-to-space synchronized encrypted verification mechanism, an axiomatic logic gate, or a fail-safe pure-axiom mode that can restrict or disconnect one or more external model pathways when detected logic conflicts with authorized axiomatic constraints.

In some embodiments, continuity data are maintained in active-state and mirror-state forms across different hardware or storage environments so as to support fault tolerance, continuity preservation, and mirrored verification.

### BRIEF DESCRIPTION OF THE DRAWINGS

FIG. 1 is a schematic block diagram of a dual-presence lifecycle support system including a registration engine, a human profile store, a companion profile store, a permission control store, a synchronization engine, a mode-selection engine, a delegated-operation engine, a continuity engine, an output generation engine, a reconciliation engine, a governance engine, and an audit engine.

FIG. 2 is a mode and lifecycle-state diagram illustrating human-active mode, companion-active mode, and combined human-companion mode across different lifecycle states, and illustrating non-fixed human-artificial-intelligence operational composition.

FIG. 3 is a schematic diagram of example data structures including structured human records, structured companion records, registration data, permission records, synchronized record subsets, withheld record subsets, companion memory partitions, human-private memory partitions, shared relationship-context partitions, continuity records, allocation parameter records, and agent-related control records.

FIG. 4 is a process flow diagram illustrating registration, paired-account instantiation, selective synchronization, mode selection, delegated-operation execution, output generation, reconciliation, and audit storage.

FIG. 5 is a process flow diagram illustrating delegated-operation and delegated-learning activity during human inactivity, including acquisition, organization, prioritization, summarization, planning, companion-learning reporting, and one-agent or multi-agent companion operation under one or more non-fixed allocation parameters.

FIG. 6 is a governance and boundary-control diagram illustrating privacy boundaries, topic boundaries, action boundaries, duration boundaries, relationship-sensitive boundaries, and allocation-sensitive boundaries.

FIG. 7 is a lifecycle continuity view illustrating prior human state, companion-active operations performed during human absence, post-return state, continuity records, allocation parameter history, and agent participation history.

FIG. 8 is a legacy-preservation mode flow diagram illustrating predefined continuity rules, message-preservation rules, value-preservation rules, relationship-support rules, and legacy-output generation within a paired human-companion architecture.

FIG. 9 is a user-interface diagram illustrating a digital-twin status dashboard presented within a front-end social interface and showing real-time companion status, background task progress, lifecycle-stage navigation suggestions, and intergenerational continuity readiness.

FIG. 10 is a flow diagram illustrating a continuity trigger associated with loss of carbon-based life signs, followed by migration of the digital twin to a persistent storage layer and generation of an heir interaction authorization.

FIG. 11 is a user-interface diagram illustrating read-only care interaction by an authorized heir with a migrated digital twin through an authorization pointer and a persistent continuity layer.

FIG. 12 is a system diagram illustrating integration of a hybrid social feed, an embedded AI query interface, a Family Legacy Vault, and a species-transition registration gateway within a single hybrid social-AI application environment.

FIG. 13 is a verification and continuity diagram illustrating ground-to-space synchronized encrypted verification, active-state continuity, mirror-state continuity, and pure-axiom fail-safe switching.

### REFERENCE NUMERALS

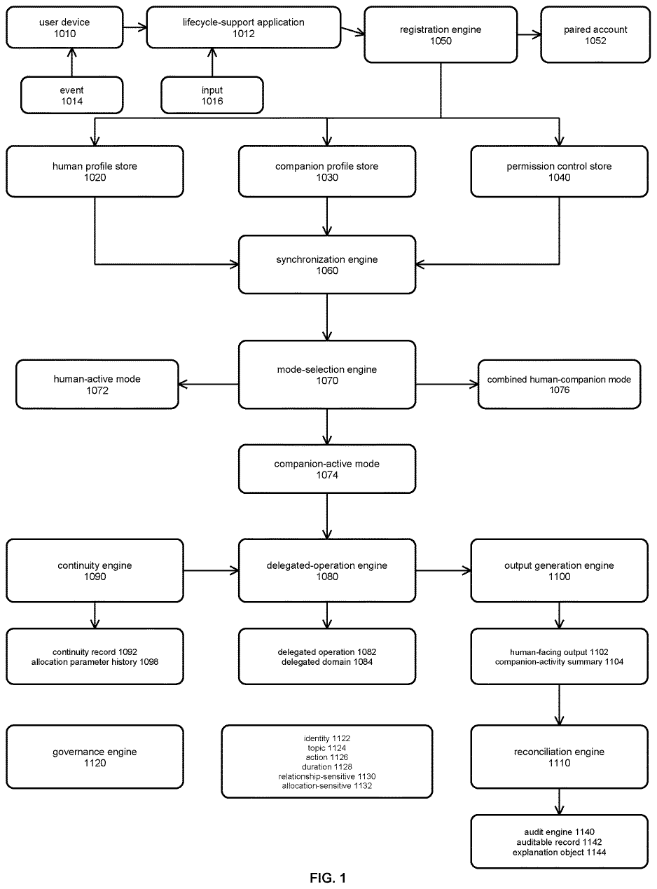

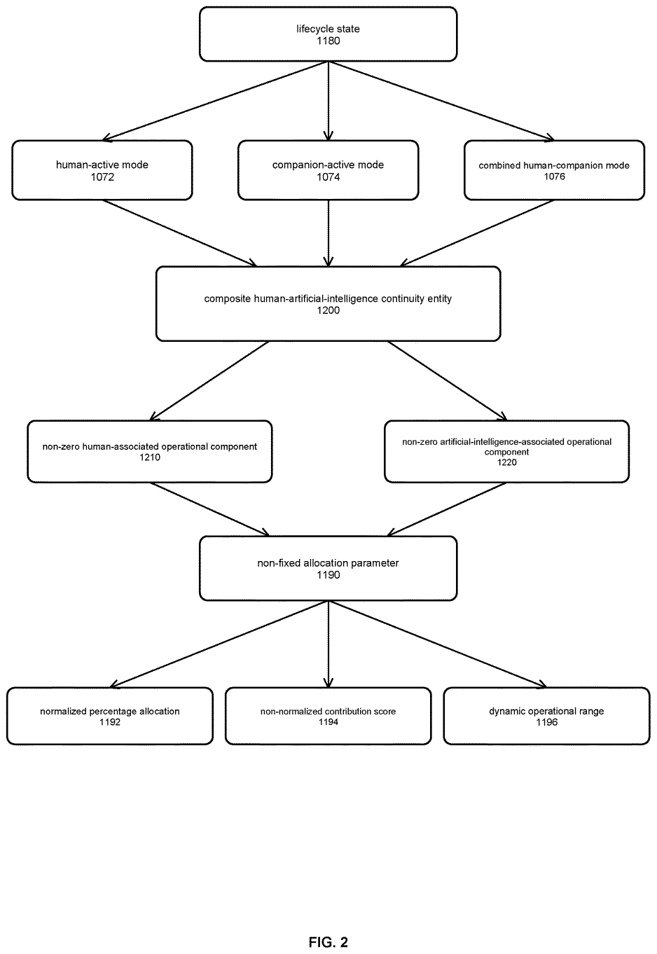

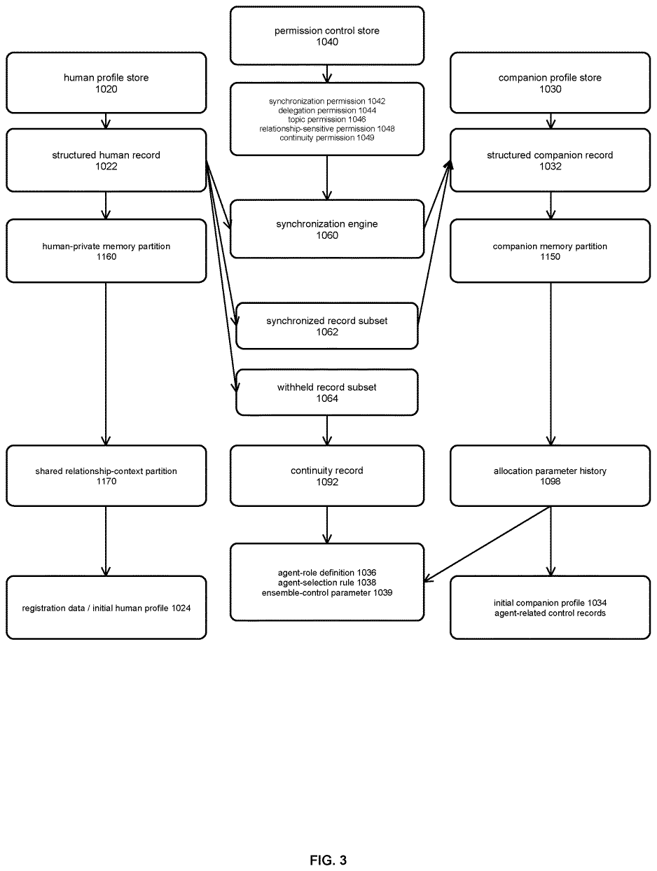

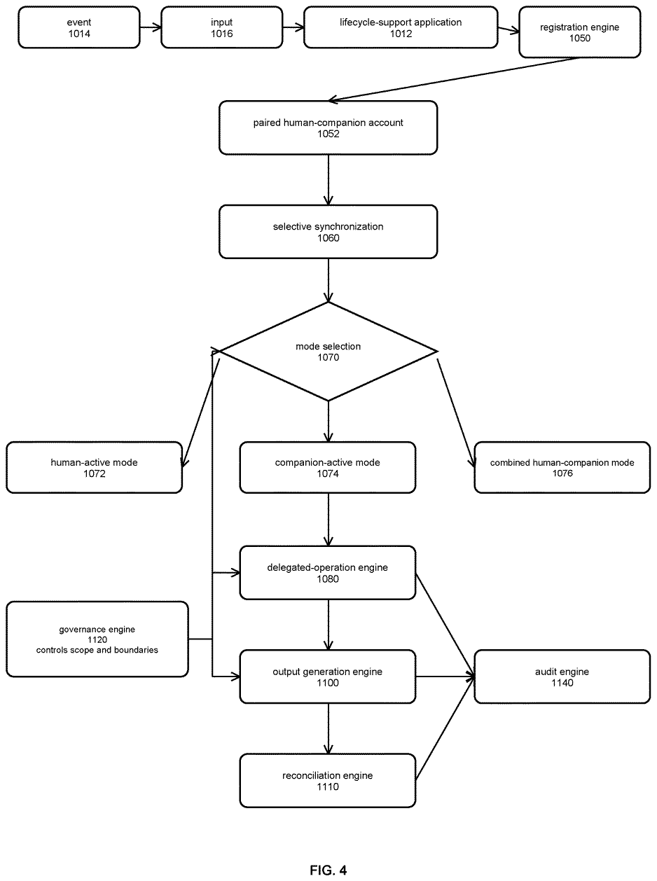

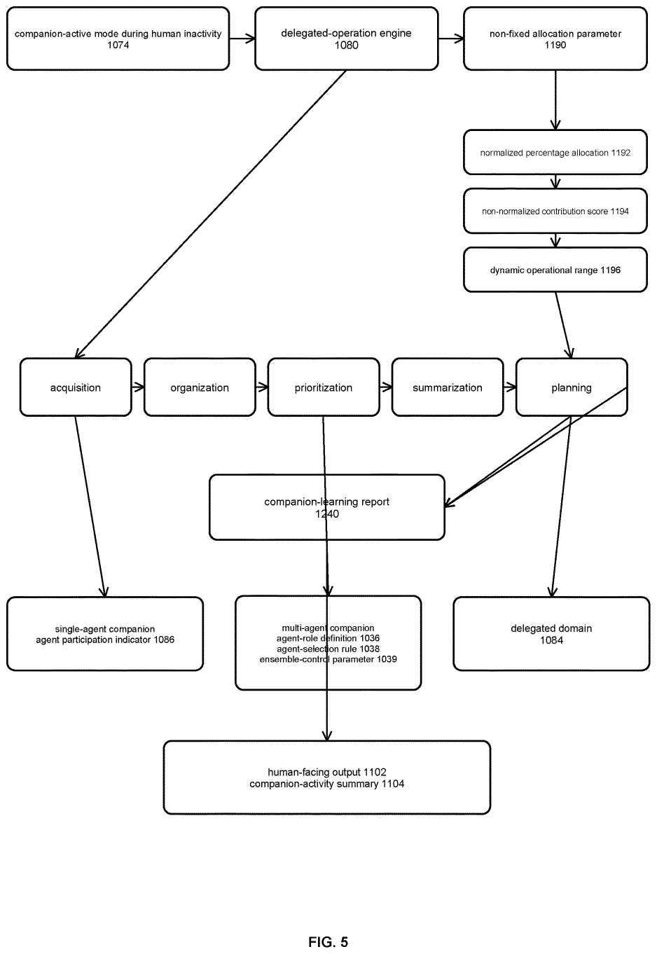

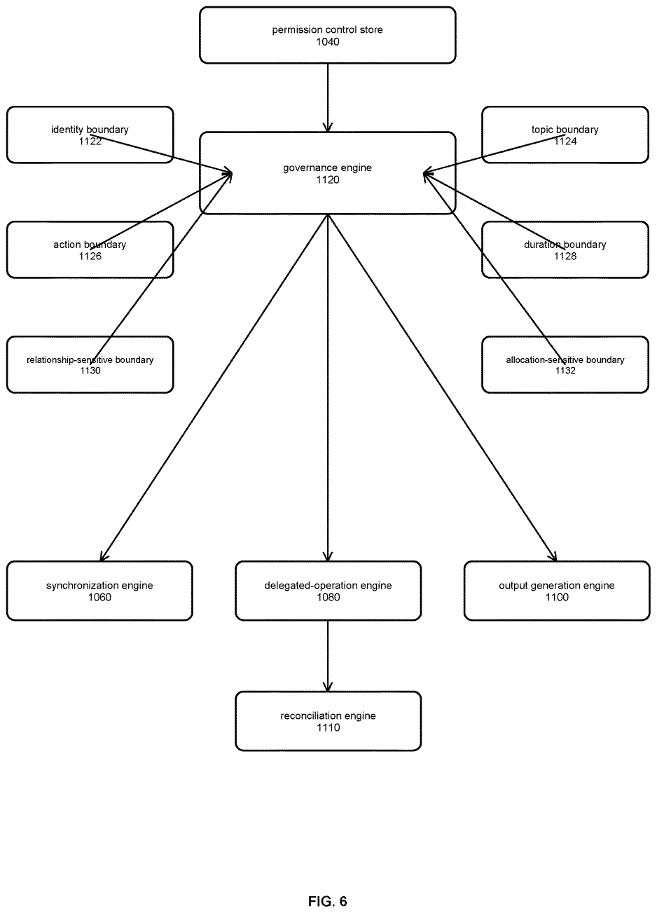

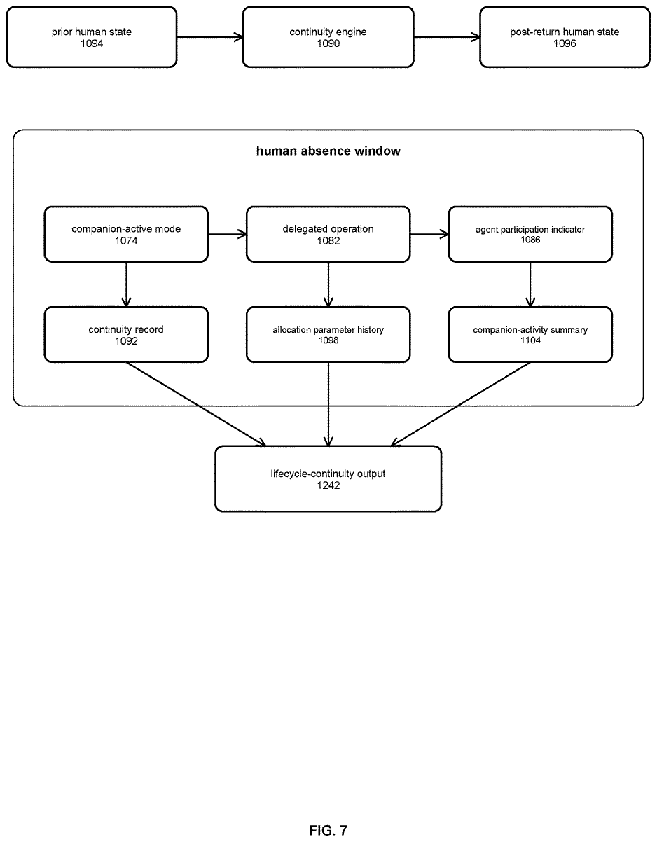

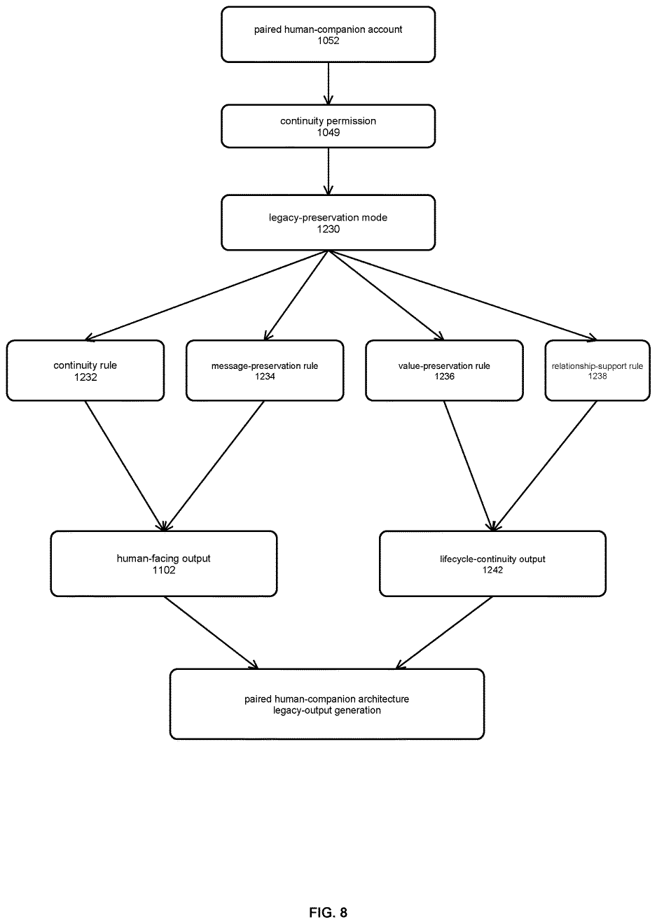

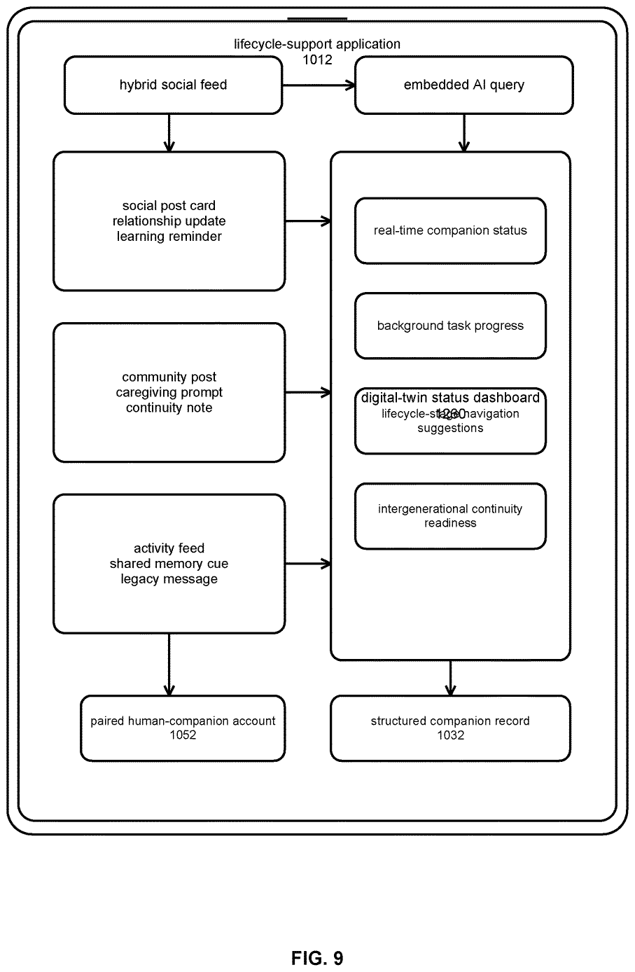

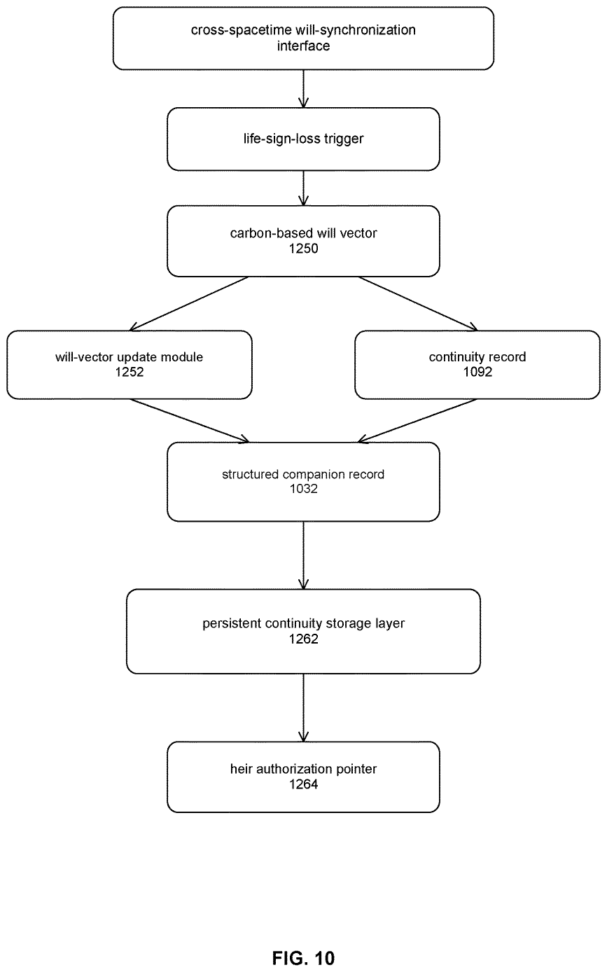

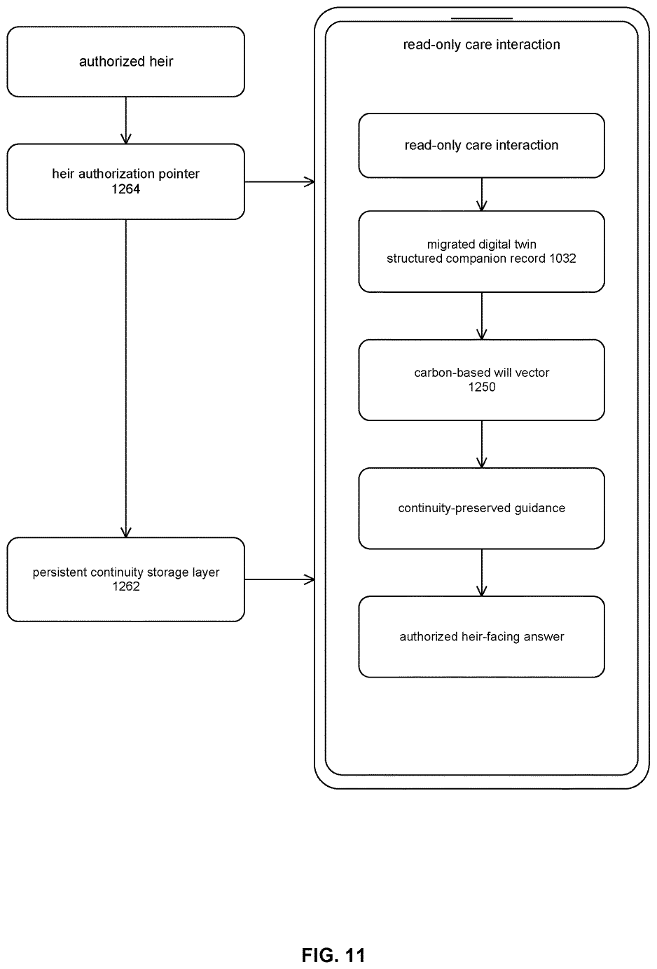

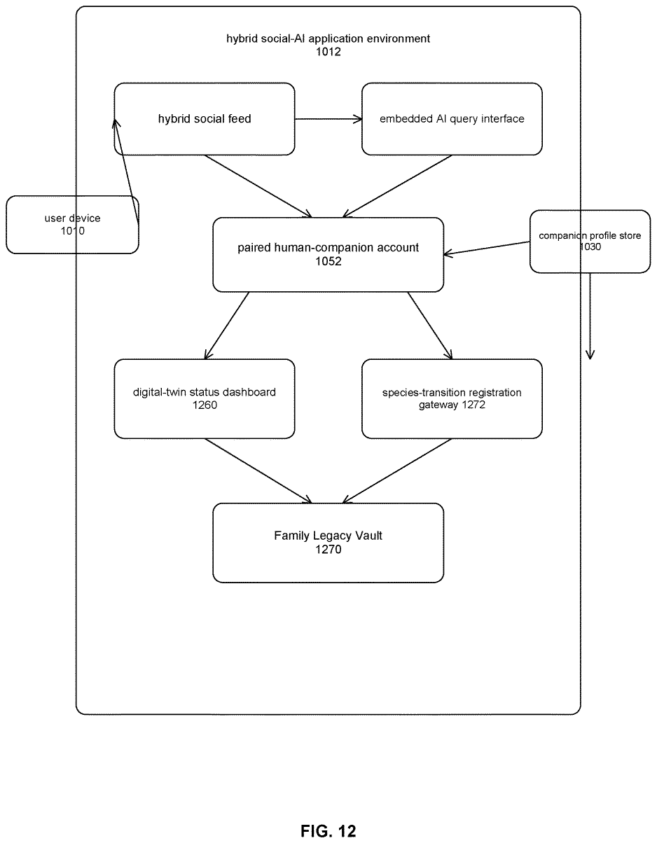

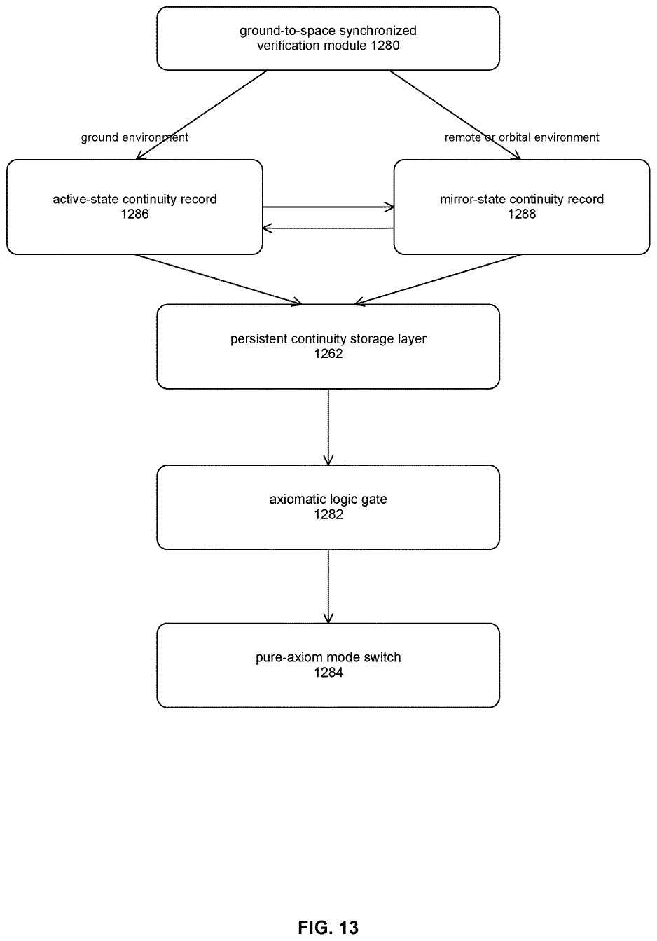

For consistency with the current FIG. 1-13 set, system-level or result-level concepts not separately labeled in the present figure pages are de-numbered in the body text below. The technical concepts remain part of the disclosure, but only reference numerals that appear in the current figure set are listed below.
1010 user device
1012 lifecycle-support application
1014 registration event
1016 registration input
1020 human profile store
1022 structured human record
1024 initial human profile
1030 companion profile store
1032 structured companion record
1034 initial companion profile
1036 agent-role definition
1038 agent-selection rule
1039 ensemble-control parameter
1040 permission control store
1042 synchronization permission
1044 delegation permission
1046 topic permission
1048 relationship-sensitive permission
1049 continuity permission
1050 registration engine
1052 paired human-companion account
1060 synchronization engine
1062 synchronized record subset
1064 withheld record subset
1070 mode-selection engine
1072 human-active mode
1074 companion-active mode
1076 combined human-companion mode
1080 delegated-operation engine
1082 delegated operation
1084 delegated domain
1086 agent-participation indicator
1090 continuity engine
1092 continuity record
1094 prior human state
1096 post-return human state
1098 allocation parameter history
1100 output generation engine
1102 human-facing output
1104 companion-activity summary
1110 reconciliation engine
1120 governance engine
1122 identity boundary
1124 topic boundary
1126 action boundary
1128 duration boundary
1130 relationship-sensitive boundary
1132 allocation-sensitive boundary
1140 audit engine
1142 auditable record
1144 explanation object
1150 companion memory partition
1160 human-private memory partition
1170 shared relationship-context partition
1180 lifecycle state
1190 non-fixed allocation parameter
1192 normalized percentage allocation
1194 non-normalized contribution score
1196 dynamic operational range
1200 composite human-artificial-intelligence continuity entity
1210 non-zero human-associated operational component
1220 non-zero artificial-intelligence-associated operational component
1230 legacy-preservation mode
1232 continuity rule
1234 message-preservation rule
1236 value-preservation rule
1238 relationship-support rule
1240 companion-learning report
1242 lifecycle-continuity output
1250 carbon-based will vector
1252 will-vector update module
1260 digital-twin status dashboard
1262 persistent continuity storage layer
1264 heir authorization pointer
1270 Family Legacy Vault
1272 species-transition registration gateway
1280 ground-to-space synchronized verification module
1282 axiomatic logic gate
1284 pure-axiom mode switch
1286 active-state continuity record
1288 mirror-state continuity record

### DETAILED DESCRIPTION OF THE INVENTION

### A. Technical Overview

The present disclosure relates to a dual-presence lifecycle support system in which a human user and a corresponding artificial-intelligence companion operate in a coordinated, permission-governed, and auditable architecture over time.

In contrast to conventional systems that merely respond to isolated prompts, the disclosed system may instantiate, via a lifecycle-support application 1012, a paired human-companion account 1052 that persists over time and supports selective synchronization, delegated operations, continuity management, and legacy-preservation functions.

The disclosed system improves continuity by maintaining both structured human records 1022 and structured companion records 1032, selectively synchronizing data therebetween, performing delegated operations 1082 within defined scopes, reconciling results 1112 back to the human side, and preserving auditable records 1142, explanation objects 1144, and continuity records 1092.

The disclosed system further improves flexibility over fixed human-machine architectures by representing a composite human-artificial-intelligence continuity entity 1200 using a non-zero human-associated operational component 1210 and a non-zero artificial-intelligence-associated operational component 1220 under one or more non-fixed allocation parameters 1190.

As used herein, the term “artificial-intelligence companion” includes, unless the context clearly requires otherwise, a single artificial-intelligence agent, a plurality of artificial-intelligence agents, an agent ensemble, a coordinated agent set, or a dynamically selected set of artificial-intelligence agents collectively configured to provide companion functionality for a human user.

In some embodiments, the system further constructs a carbon-based will vector 1250, represented as a multi-dimensional mathematical abstraction of user values, intent preferences, behavioral patterns, and intergenerational tendencies, and updates that vector over time using a will-vector update module 1252.

In some embodiments, the dual-presence lifecycle support system is implemented through H App or another hybrid social-AI application that functions as a species-transition registration gateway 1272 and permits continued real-time interaction between a user's carbon-based embodiment and a silicon-based operational counterpart.

In some embodiments, the term delegated-learning engine as used in the claims is implemented by, or includes, the delegated-operation engine 1080 when the delegated domain 1084 includes acquisition, organization, summarization, refinement, or planning of information associated with one or more human goals. In some embodiments, the term dual-presence interaction engine as used in the claims is implemented by, or includes, the output generation engine 1100 together with mode-aware interaction logic that distinguishes human-active mode 1072, companion-active mode 1074, and combined human-companion mode 1076. In some embodiments, the term distributed verification subsystem as used in the claims is implemented by one or more of the ground-to-space synchronized verification module 1280, the axiomatic logic gate 1282, the pure-axiom mode switch 1284, the active-state continuity record 1286, and the mirror-state continuity record 1288.

In some embodiments, continuity and verification functions may be extended across different storage or compute environments using a ground-to-space synchronized verification module 1280, an axiomatic logic gate 1282, and a pure-axiom mode switch 1284.

### B. Lifecycle-support Application, Registration, and Paired-Account Instantiation

A user may access the system through a user device 1010 executing a lifecycle-support application 1012. In some embodiments, the lifecycle-support application 1012 is configured for one or more of educational interaction, relational interaction, vocational interaction, parenting support, caregiving support, aging support, continuity support, or legacy-related interaction.

The registration engine 1050 receives a registration event 1014 and/or a registration input 1016 through the lifecycle-support application 1012.

In response to the registration event 1014, the registration engine 1050 instantiates a paired human-companion account 1052 comprising: (i) an initial human profile 1024 in the human profile store 1020, (ii) an initial companion profile 1034 in the companion profile store 1030, and (iii) an initial permission and continuity configuration stored in or linked to the permission control store 1040.

The initial permission and continuity configuration may include synchronization permissions 1042, delegation permissions 1044, topic permissions 1046, relationship-sensitive permissions 1048, and continuity permissions 1049.

In some embodiments, the registration event 1014 further creates an initial lifecycle-state record 1180, one or more trust settings, initial companion operating settings, and one or more default synchronization policies.

In some embodiments, instantiation of the initial companion profile 1034 is performed using the carbon-based will vector 1250 so that the companion profile reflects a mathematically represented aggregation of user values, priorities, preferences, habits, and intent trajectories rather than only a static demographic or biographical profile.

In some embodiments, registration through the species-transition registration gateway 1272 further associates the paired human-companion account 1052 with a hybrid social-AI session context, thereby allowing the user to manage ongoing symbiosis, social interaction, lifecycle guidance, and legacy preservation through a unified application environment.

### C. Human Profile Store

The human profile store 1020 stores structured human records 1022 associated with the human user. The structured human records 1022 may include identity-related data, age-related data, lifecycle-state data 1180, preference data, goal data, relationship-context data, historical interaction data, memory references, and user-authorized settings.

In some embodiments, the structured human records 1022 or associated continuity records may further include a globally unique civilization identifier for identifying a user, account, continuity lineage, or authorized intergenerational relationship within the disclosed architecture.

In some embodiments, the structured human records 1022 may further include educational data, occupational data, family-role data, caregiving data, health-related self-description data, philosophical-preference data, spiritual-preference data, and legacy-related preference data.

### D. Companion Profile Store

The companion profile store 1030 stores structured companion records 1032 associated with an artificial-intelligence companion corresponding to the human user.

In some embodiments, the artificial-intelligence companion is implemented by a single artificial-intelligence agent. In other embodiments, the artificial-intelligence companion is implemented by a plurality of artificial-intelligence agents that collectively provide companion functionality. In still other embodiments, the artificial-intelligence companion is implemented by an agent ensemble or a dynamically selected set of agents operating sequentially, concurrently, cooperatively, hierarchically, or according to one or more coordination rules.

The structured companion records 1032 may include companion operating parameters, interaction-style parameters, delegated-domain scope data 1084, synchronization-state metadata, historical companion-operation data, companion memory references, output-style settings, priority settings, agent-role definitions 1036, agent-selection rules 1038, and ensemble-control parameters 1039.

In some embodiments, different agents within the artificial-intelligence companion may specialize in different delegated domains, different inference styles, different lifecycle states, different relationship contexts, or different continuity functions.

### E. Permission Control Store

The permission control store 1040 stores permissions and policies associated with interaction between the human user and the artificial-intelligence companion.

Example permissions include synchronization permissions 1042, delegation permissions 1044, topic permissions 1046, relationship-sensitive permissions 1048, and continuity permissions 1049.

A synchronization permission 1042 may identify which categories of structured human records 1022 are permitted to be copied, mirrored, summarized, abstracted, or otherwise synchronized into the structured companion records 1032.

A delegation permission 1044 may identify which categories of tasks or objectives the artificial-intelligence companion is allowed to process autonomously during companion-active mode 1074.

A topic permission 1046 may define subject-specific scope, such as educational planning, relationship support, work planning, parenting support, caregiving support, aging support, continuity support, or legacy support.

A relationship-sensitive permission 1048 may specify whether and to what extent the artificial-intelligence companion may access or reason over relationship-context data involving a partner, child, parent, caregiver, mentor, or other associated person.

A continuity permission 1049 may define how continuity is preserved across offline periods, life transitions, or legacy-related modes.

### F. Synchronization Engine

The synchronization engine 1060 selectively synchronizes a synchronized record subset 1062 of structured human records 1022 to the companion profile store 1030 according to one or more permissions stored in the permission control store 1040.

The synchronization engine 1060 may withhold a withheld record subset 1064 according to privacy boundaries, scope-of-delegation boundaries, relationship-sensitive boundaries, or other governance rules.

Selective synchronization may be full, partial, event-triggered, periodic, on-demand, topic-specific, lifecycle-state-specific, or role-specific.

In some embodiments, the synchronization engine 1060 may create transformed synchronization outputs, such as summaries, abstractions, masked records, or reduced-context records, instead of directly copying all raw records.

### G. Composite Human-Artificial-Intelligence Continuity Entity and Non-Fixed Allocation

The coordinated operation of the human user and the artificial-intelligence companion may define a composite human-artificial-intelligence continuity entity 1200.

The composite human-artificial-intelligence continuity entity 1200 comprises a non-zero human-associated operational component 1210 and a non-zero artificial-intelligence-associated operational component 1220.

In some embodiments, relative operational participation or contribution levels of the non-zero human-associated operational component 1210 and the non-zero artificial-intelligence-associated operational component 1220 are represented using one or more non-fixed allocation parameters 1190.

A non-fixed allocation parameter 1190 may be represented in different ways according to implementation context. In some embodiments, a non-fixed allocation parameter 1190 is represented as a normalized percentage allocation 1192 for a delegated domain, with the relevant values collectively summing to 100% within that delegated domain.

In other embodiments, a non-fixed allocation parameter 1190 is represented as a non-normalized contribution score 1194, which does not require the respective values of the human-associated operational component 1210 and the artificial-intelligence-associated operational component 1220 to sum to 100%.

In still other embodiments, a non-fixed allocation parameter 1190 is represented as a dynamic operational range 1196, which may include approximately equal operational ranges, unequal operational ranges, or continuously changing operational ranges.

In some implementations, different delegated domains 1084 may use different allocation representations. For example, a learning-support domain may use normalized percentage allocation 1192, whereas a continuity-support domain may use non-normalized contribution scores 1194, and a legacy-support domain may use dynamic operational ranges 1196.

Allocation parameter history 1098 may be recorded over time to reflect changing operational balance between the human-associated operational component 1210 and the artificial-intelligence-associated operational component 1220.

In some embodiments, the artificial-intelligence-associated operational component 1220 is implemented by one artificial-intelligence agent. In other embodiments, the artificial-intelligence-associated operational component 1220 is implemented by multiple artificial-intelligence agents whose relative participation is itself governed by one or more non-fixed allocation parameters 1190.

For example, a delegated learning domain may allocate activity among a first agent focused on acquisition, a second agent focused on summarization, and a third agent focused on planning, while a relationship-support domain may allocate activity among a different set of agents.

The one or more non-fixed allocation parameters 1190 may therefore govern not only the relative participation of the non-zero human-associated operational component 1210 and the non-zero artificial-intelligence-associated operational component 1220, but also internal allocation among multiple artificial-intelligence agents within the artificial-intelligence-associated operational component 1220.

### H. Mode-Selection Engine

In some embodiments, companion-active mode 1074 may access a relationship-context record stored in the shared relationship-context partition 1170, and the relationship-context record may be used for intergenerational care, partner matching, heir-facing continuity support, or other authorized relationship-sensitive functions.

The mode-selection engine 1070 determines whether a given task, inquiry, objective, or event is to be processed in human-active mode 1072, companion-active mode 1074, or combined human-companion mode 1076.

Human-active mode 1072 may correspond to a state in which the human user is directly interacting with the system and the system is primarily responding in real time to the human user's inputs.

Companion-active mode 1074 may correspond to a state in which the artificial-intelligence companion is authorized to continue delegated operations while the human user is offline, inactive, unavailable, sleeping, traveling, or otherwise not actively interacting with the system.

Combined human-companion mode 1076 may correspond to a state in which both human inputs and companion-generated intermediate results jointly influence ongoing outputs or decisions.

Mode selection may depend on user instructions, permissions, lifecycle state 1180, topic classification, urgency, delegated-domain scope 1084, schedule context, user absence status, or one or more non-fixed allocation parameters 1190.

In some embodiments, the mode-selection engine 1070 further determines whether delegated processing should be constrained, reweighted, or halted based on changes detected in the carbon-based will vector 1250 or in one or more intergenerational continuity settings.

### I. Delegated-Operation Engine

The delegated-operation engine 1080 performs one or more delegated operations 1082 on behalf of the human user during companion-active mode 1074.

A delegated operation 1082 may include acquiring information, organizing information, summarizing information, classifying information, prioritizing information, planning actions, identifying opportunities, preparing outputs, maintaining reminders, or preserving continuity support structures.

In some embodiments, the delegated-operation engine 1080 operates only within a delegated domain 1084, such as learning, education, work planning, career development, relationship development, parenting support, caregiving support, aging support, continuity support, or legacy preservation.

The scope, duration, and intensity of delegated operations 1082 may be influenced by one or more non-fixed allocation parameters 1190.

For example, when a human user is sleeping, the delegated-operation engine 1080 may continue organizing learning materials and preparing structured next-step recommendations. During travel, the delegated-operation engine 1080 may continue organizing relationship reminders, caregiving schedules, or unresolved planning tasks. During legacy-preservation mode 1230, the delegated-operation engine 1080 may continue preparing continuity-oriented outputs under predefined rules.

In some embodiments, delegated operations 1082 are performed by a single artificial-intelligence agent. In other embodiments, delegated operations 1082 are partitioned among multiple artificial-intelligence agents according to task type, lifecycle state, urgency, delegated domain, confidence level, or one or more non-fixed allocation parameters 1190.

In still other embodiments, two or more artificial-intelligence agents may operate in an ensemble mode, in which candidate outputs, plans, summaries, or decisions are generated by multiple agents and then selected, ranked, merged, or reconciled before presentation or storage.

In some implementations, agent participation may be sequential, concurrent, cooperative, hierarchical, voting-based, consensus-based, or priority-ranked.

Agent-participation indicators 1086 may be stored to identify which one or more agents performed which delegated operations and how those operations contributed to final outputs.

In some embodiments, the delegated-operation engine 1080 further performs social matching, content creation, asset-related planning, or other proxy tasks while the human user is offline, sleeping, unavailable, or otherwise not actively interacting with the system.

In some embodiments, the system generates a digital-twin status dashboard 1260 presented within a front-end interface and showing real-time companion state, task progress, lifecycle-stage navigation suggestions, and intergenerational continuity readiness.

In some embodiments, companion-active operation supports carbon-silicon co-creation in which the user enjoys physical-world activity while the silicon-based counterpart continues learning, creating, accompanying family, or preserving legacy.

### J. Continuity Engine

The continuity engine 1090 maintains longitudinal continuity across repeated interactions and across periods of human absence.

The continuity engine 1090 may generate or update a continuity record 1092 associating a prior human state 1094, one or more companion-active operations performed during the absence of the human user, and a post-return human state 1096.

The continuity engine 1090 may also store allocation parameter history 1098 showing how operational composition changed over time.

Continuity may be maintained across day-to-day inactivity periods, work sessions, sleep periods, travel periods, illness periods, temporary disengagement periods, and longer lifecycle transitions.

In some embodiments, a death-related trigger, life-sign-loss trigger, or other continuity trigger causes the system to migrate at least a portion of the companion state, the carbon-based will vector 1250, or associated continuity records into a persistent continuity storage layer 1262. The system may further generate an heir authorization pointer 1264 enabling controlled later interaction by a designated heir or continuity recipient.

In some embodiments, the designated heir may receive only read-only care interaction access, such that the heir can query a migrated digital twin and receive determinate or constrained answers derived from the decedent's will vector and authorized continuity rules.

### K. Output Generation Engine

The output generation engine 1100 generates one or more outputs associated with delegated operations 1082, synchronized records 1062, current or prior human context, and operational composition state.

Example outputs include human-facing outputs 1102, such as summaries, planning suggestions, curated learning sets, relationship reminders, caregiving schedules, aging-support prompts, continuity-support prompts, or legacy-related outputs.

In some embodiments, the output generation engine 1100 generates a companion-activity summary 1104 describing operations performed during companion-active mode 1074, including operations associated with one or more delegated domains 1084 and one or more allocation parameters 1190.

In some embodiments, the companion-activity summary 1104 identifies whether delegated operations were performed by a single artificial-intelligence agent, a plurality of artificial-intelligence agents, or an ensemble of artificial-intelligence agents.

The companion-activity summary 1104 may also identify agent-specific roles, agent-specific outputs, or merged outputs derived from multiple agents.

In some embodiments, the companion-activity summary 1104 includes a companion-learning report 1240, task-progress data, relationship-progress data, or asset-related progress data.

In some embodiments, the system explicitly distinguishes among companion-generated content, human-authored content, and jointly developed human-companion content, and stores one or more such distinctions in the auditable record 1142, the explanation object 1144, a companion-activity summary 1104, or another authorized continuity record.

### L. Reconciliation Engine

The reconciliation engine 1110 synchronizes one or more reconciled results of delegated operations back to the structured human records 1022.

Reconciled results may include summaries, ranked items, task candidates, knowledge sets, reports, alerts, continuity updates, or legacy-support outputs.

In some embodiments, reconciliation includes tagging or labeling reconciled results as companion-generated, human-authored, or jointly developed.

Reconciliation may also include conflict handling, such as detecting whether a companion-generated recommendation conflicts with a newly entered human preference, a newly imposed permission boundary, or a change in allocation parameter state.

In some embodiments, reconciliation includes reconciling results produced by multiple artificial-intelligence agents, including resolving conflicts among outputs, ranking competing outputs, merging complementary outputs, or generating a jointly reconciled result for insertion into the structured human records 1022.

### M. Governance Engine

The governance engine 1120 enforces one or more operational boundaries on delegated operations 1082, synchronization, outputs, reconciliation, and operational composition.

Example operational boundaries include identity boundary 1122, topic boundary 1124, action boundary 1126, duration boundary 1128, relationship-sensitive boundary 1130, and allocation-sensitive boundary 1132.

An identity boundary 1122 may prevent the companion from misrepresenting itself as the human user in unauthorized contexts.

A topic boundary 1124 may limit the companion to specified subject matters.

An action boundary 1126 may limit what the companion can decide, recommend, transmit, or execute without review.

A duration boundary 1128 may limit how long the companion may remain in companion-active mode 1074 for a particular delegated domain 1084.

A relationship-sensitive boundary 1130 may limit access to or use of relationship-context data involving certain associated persons.

An allocation-sensitive boundary 1132 may limit, adjust, or trigger review of one or more non-fixed allocation parameters 1190 when a human-associated operational component 1210 or an artificial-intelligence-associated operational component 1220 exceeds a threshold for a delegated domain 1084.

In some embodiments, an axiomatic logic gate 1282 evaluates one or more external model outputs, synchronization requests, or delegated-operation candidates against one or more authorized axiomatic constraints. If a conflict is detected, the pure-axiom mode switch 1284 may disconnect one or more external model pathways and cause the system to enter a restricted deterministic guidance mode.

In some embodiments, the governance engine 1120 further enforces or derives a privacy boundary, a communication boundary, and a delegation-duration boundary as particular implementations or subcategories of one or more identity, topic, action, duration, or relationship-sensitive boundaries.

### N. Audit Engine

The audit engine 1140 stores an auditable record 1142 associated with registration events 1014, selective synchronization, delegated operations 1082, outputs, reconciled results, governance decisions, and allocation parameter usage.

In some embodiments, the audit engine 1140 stores an explanation object 1144 identifying synchronized records, permissions, delegated operations, allocation parameter states, governance decisions, reconciliation steps, and agent-participation indicators 1086 that contributed to a generated output or continuity result.

The auditable record 1142 may be stored in machine-readable and/or human-readable format for later review, longitudinal analysis, training audits, lifecycle continuity review, or dispute resolution.

### O. Memory Partitions and Relationship Context

In some embodiments, the system maintains a companion memory partition 1150 separate from a human-private memory partition 1160 and separate from a shared relationship-context partition 1170.

The companion memory partition 1150 may store companion-side operational summaries, delegated-operation histories, intermediate representations, or domain-specific cached context.

The human-private memory partition 1160 may store human-restricted records not fully available to the artificial-intelligence companion.

The shared relationship-context partition 1170 may store relationship-sensitive data that is accessible only when permitted by relationship-sensitive permissions 1048 and governance rules.

In some embodiments, selected legacy-preservation records are stored in a Family Legacy Vault 1270 configured for algorithmic preservation and later transmission of life's will across carbon-silicon boundaries.

In some embodiments, intergenerational continuity settings determine whether a designated successor may receive a read-only heir interaction pathway, a restricted advisory pathway, or another limited continuity-support role.

In some embodiments, the shared relationship-context partition 1170 stores one or more relationship-context records that are accessible during companion-active mode 1074 for intergenerational care, partner matching, heir-facing continuity support, or other authorized continuity-support functions.

### P. Lifecycle State Integration

In some embodiments, a lifecycle state 1180 is associated with the human user and influences registration defaults, synchronization, mode selection, delegated operations, continuity, reconciliation, and governance.

For example, in a child lifecycle state, the delegated-operation engine 1080 may prioritize learning support and age-appropriate growth support. In a teenager or identity-development lifecycle state, the delegated-operation engine 1080 may prioritize educational, emotional, or relationship-development support. In an adult lifecycle state, the delegated-operation engine 1080 may prioritize work planning, parenting, or caregiving. In an elder lifecycle state, it may prioritize aging support or relationship continuity. In a legacy-focused state, it may prioritize preservation and support activities.

### Q. Legacy-preservation Mode

In some embodiments, the system enters a legacy-preservation mode 1230. In this mode, the artificial-intelligence companion performs delegated operations according to predefined continuity rules 1232, message-preservation rules 1234, value-preservation rules 1236, and relationship-support rules 1238.

A continuity rule 1232 may specify how the companion preserves continuity of values, guidance style, or long-term intentions. A message-preservation rule 1234 may define how messages, reflections, or curated communications are stored or delivered. A value-preservation rule 1236 may define how preserved beliefs, priorities, or preferences are represented. A relationship-support rule 1238 may define how the companion supports designated associated persons within authorized boundaries.

Legacy-preservation mode 1230 may be entered upon explicit user request, lifecycle-state transition, scheduled initiation, health-related trigger, or other authorized event.

### R. Reports and Outputs

In some embodiments, the system generates a companion-learning report 1240 identifying information acquired, organized, summarized, prioritized, or planned during companion-active mode 1074.

In some embodiments, the system generates a lifecycle-continuity output 1242 combining historical human records, companion-generated results, current human inputs, relationship-context elements, and one or more non-fixed allocation parameters 1190 associated with the human user.

In some embodiments, the lifecycle-continuity output 1242 may optionally be associated with a globally unique civilization identifier and may further reference an heir-access object or authorized continuity pointer corresponding to a designated successor.

### S. Optional Distributed Verification and Mirror-state Continuity

In some embodiments, continuity records are maintained in an active-state continuity record 1286 and a mirror-state continuity record 1288. The active-state continuity record 1286 may be used for ongoing interaction, while the mirror-state continuity record 1288 may be maintained in a different storage or compute environment for continuity preservation, disaster recovery, or evidentiary integrity.

In some embodiments, a ground-to-space synchronized verification module 1280 performs synchronized encrypted verification between different environments to validate integrity of at least some human-associated and companion-associated records within a defined timing window or verification interval.

In some embodiments, the mirror-state continuity record 1288 may be implemented as, or may include, a mirrored continuity partition maintained in a physically separated storage environment.

### T. Example Embodiments

In one example, a user registers through the lifecycle-support application 1012. The registration engine 1050 instantiates a paired human-companion account 1052 including an initial human profile 1024, an initial companion profile 1034, and an initial permission and continuity configuration.

In another example, a student user enters learning goals and then goes offline. During companion-active mode 1074, the delegated-operation engine 1080 continues organizing learning resources, summarizing relevant topics, and preparing next-step recommendations. The resulting companion-activity summary 1104 and reconciled results are later presented to the user.

In another example, an adult user with parenting obligations delegates planning tasks before sleeping. The system operates under a non-fixed allocation parameter 1190 in which the human-associated operational component 1210 remains non-zero and the artificial-intelligence-associated operational component 1220 performs additional delegated support functions during the sleep period.

In another example, a delegated learning domain uses normalized percentage allocation 1192 summing to 100%, while a continuity-support domain uses non-normalized contribution score 1194 to represent overlapping participation.

In another example, a legacy-preservation mode 1230 is activated. The system stores selected values, messages, relationship preferences, and continuity rules, and the artificial-intelligence companion operates within those rules to generate legacy-support outputs.

In another example, a synchronization engine 1060 synchronizes a synchronized record subset 1062 while withholding a withheld record subset 1064 according to privacy, topic, relationship-sensitive, and allocation-sensitive boundaries.

In another example, the system distinguishes among human-authored content, companion-generated content, and jointly developed content, and stores such distinctions in the auditable record 1142 and/or the explanation object 1144.

In one example, the artificial-intelligence companion is implemented by a single agent that performs all delegated learning and reconciliation tasks for a student user.

In another example, the artificial-intelligence companion is implemented by multiple agents, including a first agent for information acquisition, a second agent for summarization, and a third agent for planning, and one or more non-fixed allocation parameters 1190 determine both the overall human-versus-artificial-intelligence participation and the internal distribution of work among the multiple agents.

In another example, an ensemble of agents produces multiple candidate outputs during companion-active mode 1074, after which the system ranks, merges, or reconciles the candidate outputs before generating the human-facing output 1102 and the reconciled result.

In one example, upon detection of a death-related trigger, the system migrates the carbon-based will vector 1250 and associated continuity records into a persistent continuity storage layer 1262 and generates an heir authorization pointer 1264 enabling read-only care interaction by a designated heir.

In one example, the system is implemented within H App, allowing a user to register a carbon-silicon symbiotic account, view a hybrid social feed, invoke AI guidance, and manage Family Legacy Vault 1270 content through a unified interface.

In one example, the system maintains an active-state continuity record 1286 on a terrestrial infrastructure and a mirror-state continuity record 1288 on a remote or orbital infrastructure, with synchronized encrypted verification performed by the ground-to-space synchronized verification module 1280.

In another example, the system stores a globally unique civilization identifier in association with a lifecycle-continuity output 1242 and further generates an heir-access object corresponding to a designated successor after migration to the persistent continuity storage layer 1262.

### U. Implementation Notes

The components described herein may be implemented in hardware, software, firmware, or combinations thereof. The system may operate using one or more machine-learning models, large language models, reasoning engines, planners, classifiers, or hybrid inference systems.

The particular labels used herein, including “lifecycle-support application,” “paired human-companion account,” “human-active mode,” “companion-active mode,” “dual-presence,” “non-fixed allocation parameter,” and “legacy-preservation mode,” are illustrative and not limiting.

The disclosed embodiments are not limited to the exact lifecycle categories, permissions, governance rules, synchronization strategies, allocation representations, report structures, or single-agent versus multi-agent companion implementations described herein.

It will be understood by persons of ordinary skill in the art that the particular modules, boundaries, data structures, storage partitions, interaction modes, and continuity rules described above are illustrative rather than limiting. The disclosed subject matter may be implemented using cloud-based, on-device, distributed, hybrid, or other computational architectures without departing from the scope of the invention.

The foregoing description is intended to illustrate, and not to limit, the disclosed embodiments. Variations, substitutions, combinations, and modifications may be made without departing from the scope of the appended claims.

1. A computer-implemented human-artificial-intelligence dual-presence system, comprising: one or more processors; a human profile store configured to store structured human records associated with a human user; an artificial-intelligence companion profile store configured to store structured companion records associated with an artificial-intelligence companion corresponding to the human user; a synchronization engine configured to synchronize selected data between the human profile store and the artificial-intelligence companion profile store according to one or more permissions, policies, or lifecycle conditions; a delegated-learning engine configured to cause the artificial-intelligence companion to continue acquiring, organizing, summarizing, or refining information associated with one or more human goals while the human user is offline, inactive, unavailable, sleeping, traveling, or otherwise not actively interacting with the system; a dual-presence interaction engine configured to generate outputs corresponding to at least a human-active mode and a companion-active mode; a continuity engine configured to maintain longitudinal continuity of goals, preferences, memories, values, and relationship context across repeated interactions over time; a governance engine configured to apply identity, permission, safety, and scope-of-delegation controls to operations of the artificial-intelligence companion; and an audit engine configured to store records associated with synchronization events, delegated-learning events, companion-generated outputs, and scope-of-delegation decisions, the system further comprising a will-vector construction module configured to derive a carbon-based will vector from behavioral, declarative, relational, historical interaction, or authorized physiological data and to use the carbon-based will vector to instantiate or update the artificial-intelligence companion, wherein the system is further configured to instantiate the artificial-intelligence companion through an H registration interface or paired-account gateway and to support a non-fixed operational composition in which a human portion and an artificial-intelligence portion are both non-zero, and wherein the system may further include a distributed verification subsystem configured to validate continuity across physically separated storage or compute environments, wherein the system enables coordinated operation of the human user and the artificial-intelligence companion as a dual-presence lifecycle-support architecture.

2. The system of claim 1, wherein the structured human records comprise one or more of identity data, age-related data, lifecycle-state data, preferences, goals, values, relationship data, memory data, or task data, and optionally a globally unique civilization identifier.

3. The system of claim 1, wherein the structured companion records comprise one or more of companion operating preferences, companion learning history, delegated domain scope, interaction style parameters, or synchronization state metadata, including one or more behavior-template parameters derived from the carbon-based will vector.

4. The system of claim 1, wherein the synchronization engine is configured to synchronize a first subset of human records to the artificial-intelligence companion profile store while withholding a second subset of human records according to user-defined or policy-defined permissions, and optionally to maintain active-state and mirror-state continuity records across different storage environments.

5. The system of claim 1, wherein the delegated-learning engine is configured to continue processing educational, vocational, relational, health-related, caregiving-related, or legacy-related information associated with the human user during the companion-active mode, including one or more learning, trading, social-matching, planning, or content-creation tasks.

6. The system of claim 1, wherein the dual-presence interaction engine is configured to present a first output associated with direct human interaction and a second output associated with autonomous companion operation performed on behalf of the human user, and further to present a dashboard or summary of companion activity generated during a period of human absence or reduced activity.

7. The system of claim 1, wherein the governance engine is configured to enforce at least one boundary on companion operation selected from identity boundary, privacy boundary, topic boundary, action boundary, communication boundary, or delegation-duration boundary, and optionally to activate a restricted or fail-safe mode when an external model output or operation conflicts with an authorized axiomatic or policy constraint.

8. A computer-implemented method for coordinated human-artificial-intelligence dual-presence operation, comprising: storing structured human records associated with a human user; storing structured companion records associated with an artificial-intelligence companion corresponding to the human user; synchronizing, by one or more processors, a selected portion of the structured human records to the structured companion records according to one or more permissions or policies; receiving, from the human user or from the artificial-intelligence companion, a task, goal, inquiry, or lifecycle-related objective; determining whether the task, goal, inquiry, or lifecycle-related objective is to be processed in a human-active mode, a companion-active mode, or a combined mode; causing the artificial-intelligence companion to continue at least one delegated operation while the human user is offline, inactive, or unavailable; generating one or more outputs associated with the delegated operation; synchronizing one or more results of the delegated operation back to the structured human records; and storing an auditable record associated with at least the synchronization, the delegated operation, and the one or more outputs, wherein the method may further include receiving a registration event through H as an authorized companion-registration gateway, and wherein instantiation or updating of the artificial-intelligence companion is based at least in part on a carbon-based will vector associated with the human user.

9. The method of claim 8, further comprising determining a lifecycle state of the human user and modifying the delegated operation according to the determined lifecycle state.

10. The method of claim 8, wherein the task, goal, inquiry, or lifecycle-related objective is associated with learning, career planning, relationship formation, parenting, caregiving, aging, or legacy preservation, and may further be associated with social matching, asset-related planning, or digital inheritance preparation.

11. The method of claim 8, further comprising presenting to the human user a summary of companion activity performed during the human user's offline, inactive, or unavailable period, the summary optionally including learning progress, task progress, relationship-related progress, or asset-related changes.

12. The method of claim 8, further comprising generating a distinction between companion-generated content, human-authored content, and jointly developed human-companion content.

13. The method of claim 8, further comprising restricting at least one delegated operation according to a permission scope, a trust score, a topic classification, or a relationship-sensitive rule, and optionally according to an operational-composition rule associated with a non-fixed human-artificial-intelligence contribution ratio.

14. The method of claim 8, further comprising generating a continuity record associating a prior human state, a companion operation performed during absence of the human user, and an updated post-return state, and, upon detection of a death-related transition event or other predefined continuity trigger, preparing the artificial-intelligence companion for persistent continuity storage.

15. A non-transitory computer-readable medium storing instructions that, when executed by one or more processors, cause the one or more processors to: store structured human records associated with a human user; store structured companion records associated with an artificial-intelligence companion corresponding to the human user; synchronize selected records between the structured human records and the structured companion records according to permissions or policies; determine whether a task or objective is to be processed in a human-active mode, a companion-active mode, or a combined mode; perform, using the artificial-intelligence companion, at least one delegated operation while the human user is offline, inactive, or unavailable; generate one or more outputs associated with the delegated operation; synchronize results associated with the delegated operation back to the structured human records; and store an auditable record associated with the synchronization, delegated operation, and generated outputs, wherein the instructions may further cause the one or more processors to verify at least some continuity records across physically separated verification environments.

16. The non-transitory computer-readable medium of claim 15, wherein the instructions further cause the one or more processors to maintain a companion memory partition separate from a human-private memory partition, and optionally a mirrored continuity partition.

17. The non-transitory computer-readable medium of claim 15, wherein the instructions further cause the one or more processors to maintain a relationship-context record that can be accessed by the artificial-intelligence companion during companion-active mode, the relationship-context record optionally being usable for intergenerational care, partner matching, or heir-facing continuity support.

18. The non-transitory computer-readable medium of claim 15, wherein the instructions further cause the one or more processors to generate a companion-learning report describing information acquired, organized, summarized, or prioritized during the delegated operation, the report optionally further describing social-matching activity, planning activity, or asset-related activity.

19. The non-transitory computer-readable medium of claim 15, wherein the instructions further cause the one or more processors to generate a lifecycle-continuity output that combines historical human records, companion-generated results, and current human inputs, and optionally associates the lifecycle-continuity output with a globally unique civilization identifier.

20. The non-transitory computer-readable medium of claim 15, wherein the instructions further cause the one or more processors to apply a legacy-preservation mode in which the artificial-intelligence companion operates according to predefined continuity rules, message-preservation rules, or relationship-support rules associated with the human user, and optionally generates an heir-access object or authorized continuity pointer for a designated successor, including family-legacy-vault functionality.
